(19) United States
(12) Patent Application Publication
(10) Pub. No.: US 2012/0227772 A1
(43) Pub. Date: Sep. 13, 2012

(54) AUTOMATIVE AIR CONDITIONING FLUSH SYSTEM

(76) Inventor: Theldon Richardson, Humble, TX (US)

(21) Appl. No.: 13/043,629

(22) Filed: Mar. 9, 2011

(51) Int. Cl. B08B 3/00

(52) U.S. Cl. 134/110

(57) ABSTRACT

A flush system for flushing an air conditioning system comprising: a flush fill tank; an input connector which connects to the flush fill tank; a recycle catch tank; an output connector which connects to the catch tank via a filter; an air pressure connection, where the air pressure connection supplies air pressure to the flush fill tank and provides air pressure to flush the air conditioning system; and a water separator between the air connection and flush fill tank. The flush system may further include an air valve and an air regulator connection at the air pressure connection, where the valve and regulator provide a means to control air pressure in the flush system. The flush system may also include a first hose connected between the input connector and an evaporator or condenser of the air conditioning system; and a second hose connected between the output connector and an evaporator or condenser of the air conditioning system.

### BACKGROUND OF THE INVENTION

1. Field of Invention

The present invention relates to a flush system used to flush an automotive air conditioning system.

2. Description of Related Art

The typical air conditioning system of a vehicle utilizes a refrigerant that must be occasionally be flushed to remove contaminants and impurities due to use over a period of time. Flushing the system is required due to the contaminants and impurities that build up over a period of time within the refrigerant and there is the need to flush this refrigerant to prevent the failure of the air conditioning system. Filters are provided on a typical air conditioning system and some type of cleaning cycle is needed to allow for the filtering and cleaning of the refrigerant. However at some point it is necessary in each air conditioning system to flush the refrigerant and flush the entire system to remove debris, impurities and contaminants from within the system. One example of a flushing system for refrigeration system components is disclosed in U.S. Patent Application No. 2006/0234896 which discloses a method and apparatus of cleaning a component of an air conditioning or refrigeration system which provides for flushing liquid solvent through the components to remove contamination from the components by vaporizing the solvent, flushing through the components and thus a removal of the contamination from the vaporized solvent.

It is therefore the object of the present invention to provide an all-in-one flushing system that includes a supply valve, air regulator and water separator therefore capable of providing a quick and efficient means to flush an air conditioning system.

### SUMMARY OF THE INVENTION

The present invention relates to a flush system for flushing an air conditioning system comprising: a flush fill tank; an input connector which connects to the flush fill tank; a recycle catch tank; an output connector which connects to the catch tank via a filter; an air pressure connection, where the air pressure connection supplies air pressure to the flush fill tank and provides air pressure to flush the air conditioning system; and a water separator between the air connection and flush fill tank. The flush system may further include an air valve and an air regulator connection at the air pressure connection, where the valve and regulator provide a means to control air pressure in the flush system. The flush system may also include a first hose connected between the input connector and an evaporator or condenser of the air conditioning system; and a second hose connected between the output connector and an evaporator or condenser of the air conditioning system.

### BRIEF DESCRIPTION OF DRAWINGS

FIG. 1 depicts a flush system in accordance with the present invention.

FIG. 1A depicts a hose used in conjunction with the flush system according to the present invention.

### DETAILED DESCRIPTION

The present invention relates to a flushing system that is utilized to flush an automotive air conditioning system. The flushing system according to the present invention provides the means to remove contamination that may exist within the air conditioning system and therefore prevent the optimum operation of the system. The flushing system according to the present invention may be connected to an evaporator or a condenser via a connection means into a 2-gallon catch tank for subsequent use. Once connected to the system the flush provides sufficient air pressure to push the flush through the flush system and therefore remove contaminants or other debris that may be within the air conditioning system.

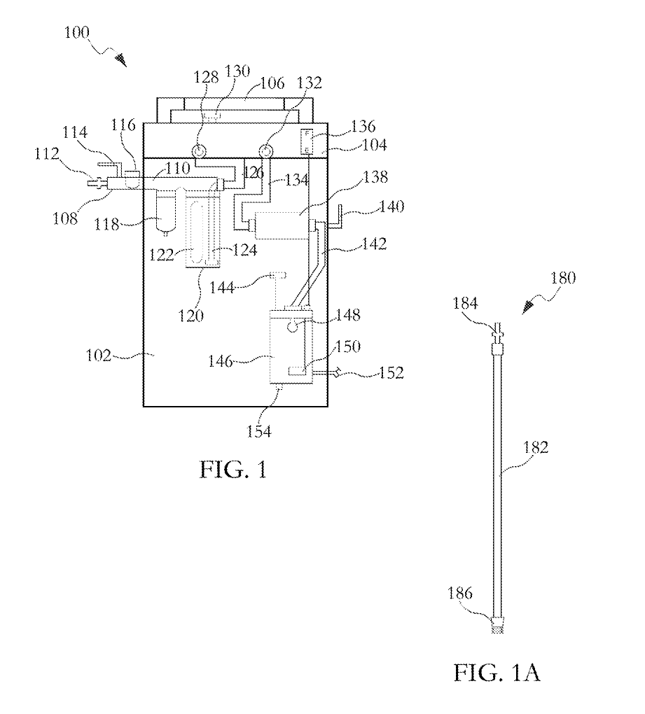

In reference to FIG. 1, a flush system 100 according to the present invention is depicted. The flush system 100 according to present invention provides various components used in conjunction to achieve the flushing of an air conditioning system. The flushing system 100 includes a flush fill tank 122 used in conjunction with a recycle catch tank 146. Input connector 128 and output connector 132 are provided at a top enclosure 104 of the flush system 100. A hose 180, as shown in FIG. 1A, is used in conjunction with the flush system 100 to flush the air conditioning unit of a vehicle.

Further components of the flush system 100 include an air hose connector 112 that extends from one side of the flush system 100. The air hose connector 112 extends from an outer tubing 108 that connects with inner tubing 110 leading past a water separator 118 then connecting into the flush fill tank 122. The flush fill tank 122 is contained within a tank enclosure 120 that has input tubing 124 leading from the tank 122. Also included with the air hose connector 112 are an air valve 114 and an air regulator 116 that are shown on the outer tubing 108. The air valve 114 and air regulator 116 provide the means to control air pressure directed into the flush fill tank 122. The flush fill tank 122 and tank enclosure at 120 are within a bottom enclosure 102 of the flush system 100. A connector tubing 126 leads to the input connector 128 of the flush system 120. The input connector 128 receives a male connector 184 shown on hose 180 in FIG. 1A. The female connector 186 of the hose 180 connects to any adapter on the condenser or evaporator of the air conditioning unit. Between the male connector 184 and female connector 186 is hose tubing 182.

The flush system 100 further includes an output connector 132, which leads to a filter 138 via the connector tubing 134. The filter 138 connects through an output tube 142 to the recycle catch tank 146. A splash sock 148 is provided within the recycle catch tank 146 that provides an entry into the catch tank 146. The catch tank 146 further includes a cleanup 154 at the bottom portion thereof. A refill drain 152 extends outwardly from the catch tank 146 and protrudes from the bottom enclosure 102 as shown in FIG. 1. A vent 144 is also provided that extends from the catch tank 146 for venting the tank 146 and a gauge 136 provided for the catch tank 146, where the gauge 136 monitors the fluid level in the catch tank 146.

The flush system 100 is utilized to flush the air conditioning system of a vehicle. During use as stated above the male connector 184 is connected to the input connector 128 of the flush system 100. The female connector 186 is connected to either the condenser or evaporator of the air conditioning unit and either the input or output of either device. Any connector hoses that are connected to the evaporator or condenser are removed and disconnected prior to the installation of the flush system 100 onto the air conditioning unit. The output connector 132 is connected to the respective condenser or evaporator that is being used to flush the air conditioning unit. Air pressure is provided through the air hose connector 112 and during use the pressure may be set using the air pressure regulator 116 to about 50 PSI. The flush tank 122 is filled with the appropriate solvent for flushing the air conditioning unit. The solvent is put into the flush tank 122 via the pressure fill cap 130 provided at the top closure 104 of the flush system 100. Once the air input is connected and set at appropriate pressure along with the input of the solvent in the flush tank 122, the air valve 114 is moved to allow 50 PSI of air to push the flush up the pickup tube or input tube 126 into the condenser inside and flush will come out of the condenser outside to the output connector 132. The flush enters through the output connector 132 after it passes through the filter 138 where the filter 138 helps to filter out the contaminants within the system. After the flushing is complete the flush is drained into the recycled catch tank 146 where there is a refill drain 152 provided to drain the tank 146 for refilling. After the flushing of the air conditioning unit is completed 60 PSI of air pressure is blown through the system to make sure that all the flush solvent is out of the system.

The flush system 100 according to the present invention is utilized to flush and clean an existing air conditioning unit of a motor vehicle. A handle 106 is provided at the top of the flush system 100 to maneuver the flush system into position for use on any motor vehicle air conditioning unit. During use this system provides an efficient and effective means to flush any existing motor vehicle air conditioning unit. The instant invention has been shown and described in what it considers to be the most practical and preferred embodiments. It is recognized, however, that departures may be made there from within the scope of the invention and that obvious modifications will occur to a person skilled in the art.

What is claimed is:

1. A flush system for flushing an air conditioning system comprising:
a. a flush fill tank;
b. an input connector which connects to the flush fill tank;
c. a recycle catch tank;
d. an output connector which connects to the catch tank via a filter;
e. an air pressure connection, where the air pressure connection supplies air pressure to the flush fill tank and provides air pressure to flush the air conditioning system; and
f. a water separator between the air connection and flush fill tank.

2. The flush system according to claim 1, further including an air valve and an air regulator connection at the air pressure connection where the valve and regulator provide a means to control air pressure in the flush system.

3. The flush system according to claim 1, further including a first hose connected between the input connector and an evaporator or condenser of the air conditioning system; and a second hose connected between the output connector and an evaporator or condenser of the air conditioning system.

4. The flush system according to claim 1, further including a bottom enclosure, where the bottom enclosure houses the flush fill tank and recycle catch tank; and a top enclosure, where top enclosure includes the input connection and output connection.

5. The flush system according to claim 4, further including a gauge, where the gauge monitors the fluid level in the catch tank.

6. The flush system according to claim 4, where the top enclosure further includes a pressure fill cap.
